(19) United States
(12) Patent Application Publication
(10) Pub. No.: US 2022/0348102 A1
(43) Pub. Date: Nov. 3, 2022

(54) CONTROL OF ELECTRIC VEHICLE CHARGING

(71) Applicant: LIIKENNEVIRTA OY / VIRTA LTD, Helsinki (FI)

(72) Inventor: Jussi AHTIKARI, Helsinki (FI)

(73) Assignee: LIIKENNEVIRTA OY / VIRTA LTD, Helsinki (FI)

(21) Appl. No.: 17/763,999

(22) PCT Filed: Sep. 22, 2020
(86) PCT No.: PCT/FI2020/050612

§ 371 Date: Mar. 25, 2022

(30) Foreign Application Priority Data
Sep. 26, 2019 (FI) 20195818

(51) Int. Cl. B60L 53/63; B60L 53/62; B60L 53/68; B60L 53/67

(52) U.S. Cl. CPC B60L 53/63; B60L 53/62; B60L 53/68; B60L 53/67

(57) ABSTRACT

A method, apparatus, and computer program product for the control of electric vehicle (EV) charging enabling non-real-time remote monitoring and adjustments of electrical current consumed at EV charging stations, without causing an electrical grid to be. At least one EV charging station is first pre-instructed to provide an EV with a station current when a charging session for the EV is initiated at the EV charging station. The station current is ≤a maximum allowable current of the EV charging station. After the initiation of charging, an actual current consumed during the charging is monitored remotely in non-real time. Next, a ratio of the actual current consumed by the EV to the charging station is calculated and used to decide whether to change the current provided by the EV charging station. After that, EV charging station is instructed, on a non-real-time basis, to operate in accordance with the decision made.

### TECHNICAL FIELD

The present disclosure relates generally to electric vehicles, and more specifically to a method, apparatus, and computer program product for the control of electric vehicle charging.

### BACKGROUND

There are a lot of commercially available solutions for the control of electric vehicle (EV) charging. These solutions typically rely on real-time monitoring of electrical current that EVs use for charging at EV charging stations. More specifically, this real-time monitoring is done locally, meaning that a monitoring device configured to monitor and adjust the electrical current is in the same physical location as the EV charging stations.

Although some other solutions in the market use remote monitoring and adjustments of the electrical current consumed by the EVs at the EV charging stations, they still require that the monitoring is done in real time. In other words, whenever a change happens (an EV starts or stops charging, or changes charging current it is using), it is monitored immediately in real time and the adjustments are also done immediately. The reason why the monitoring needs to be done in real time is to protect an electrical grid and fuses—if adjustments are not made in real time in the existing solutions, the EVs will overload the grid and blow the fuses. For example, if one EV first charges with 10 A, and then raises its electrical input to 30 A, there will be about 2-10 seconds to adjust the electrical current of other EVs before the fuses blow.

However, the real-time remote monitoring used in the existing solutions requires high-speed and intensive data communication between the EV charging stations and a remote monitoring center, as well as installations of special local hardware at the EV charging stations. This may be complicated and not cost-effective, and may be subject to installation errors.

### SUMMARY

This summary is provided to introduce a selection of concepts in a simplified form that are further described below in the detailed description. This summary is not intended to identify key features or essential features of the present disclosure, nor is it intended to be used to limit the scope of the present disclosure.

It is an object of the present disclosure to provide the control of EV charging.

The object above is achieved by the features of the independent claims in the appended claims. Further embodiments and examples are apparent from the dependent claims, the detailed description and the accompanying drawings.

According to a first aspect, a method for the control of electric vehicle (EV) charging is provided, which comprises the operations of:
(a) pre-instructing at least one EV charging station to provide an EV with a station current when a charging session for the EV is initiated at the at least one EV charging station, the station current being less than or equal to a maximum allowable current of the at least one EV charging station;
(b) after the initiation of the charging session, performing non-real-time remote monitoring of an actual current consumed by the EV during the charging session;
(C) calculating a ratio of the actual current consumed by the EV to the station current of the at least one EV charging station;
(d) based on the ratio, deciding whether to decrease, maintain or increase the station current provided by the at least one EV charging station; and
(e) instructing, on a non-real-time basis, the at least one EV charging station to operate in accordance with the decision made in operation (d).

By so doing, it is possible to monitor and adjust the current consumed by the EV from a different geographical location (even a different country) than that where the at least one EV charging station is deployed. Moreover, this embodiment may enable non-real-time remote monitoring and adjustments of the electrical current consumed by EVs at EV charging stations, without causing an electrical grid to be overloaded and fuses to blow.

In one implementation form of the first aspect, operation (b) is performed by receiving actual-current measurements sent by the at least one EV charging station at regular intervals during the charging session. This may allow significantly reducing the requirements for the speed and intensity of data communication between the at least one EV charging station and a remote monitoring center.

In another implementation form of the first aspect, operation (b) is performed by receiving the actual-current measurements sent by the at least one EV charging station at regular intervals and each time when the actual current changes during the charging session. This may provide more efficient non-real-time remote monitoring of the actual current.

In one implementation form of the first aspect, operations (a), (b) and (e) are performed by using Open Charge Point Protocol (OCPP) messages. This may provide more efficient data communication between the at least one EV charging station and the remote monitoring center.

In one implementation form of the first aspect, it is decided in operation (d) to decrease the station current if the ratio is less than 0.80, to maintain the station current if the ratio is within the range of 0.80 to 0.90, or to increase the station current if the ratio is more than 0.90. By so doing, the current adjustments may be made more efficiently.

In one implementation form of the first aspect, there are two or more EV charging stations at which charging sessions are initiated for EVs. Each EV charging station is characterized by the same maximum allowable current. In this case, the method is performed to control the EV charging at each of the two or more EV charging stations. This makes the method more flexible in use.

In one implementation form of the first aspect, the two or more EV charging stations are combined in a group of EV charging stations. The group of EV charging stations is characterized by a total current, and the maximum allowable current of the EV charging stations is less than the total current. In this case, the station current is calculated as min(I₁, I₂), where min( ) is the function that returns the smallest value from the numbers provided, I₁ is the maximum allowable current of the EV charging stations, and I₂=Iₜₒₜₐₗ/N is the current obtained by evenly distributing the total current Iₜₒₜₐₗ of the group of EV charging stations among all N EVs that have initiated the charging sessions at the current time. By using the station current thus calculated, one may provide load balancing in the whole electrical grid.

According to a second aspect, an apparatus for the control of electric vehicle (EV) charging is provided, which comprises at least one processor and a memory coupled to the at least one processor. The memory stores processor-executable instructions which, when executed by the at least one processor, cause the at least one processor to:
(a) pre-instruct at least one EV charging station to provide an EV with a station current when a charging session for the EV is initiated at the at least one EV charging station, the station current being less than or equal to a maximum allowable current of the at least one EV charging station;
(b) after the initiation of the charging session, perform non-real-time remote monitoring of an actual current consumed by the EV during the charging session;
(c) calculate a ratio of the actual current consumed by the EV to the station current of the at least one EV charging station;
(d) based on the ratio, decide whether to decrease, remain or increase the station current provided by the at least one EV charging station; and
(e) instruct, on a non-real-time basis, the at least one EV charging station to operate in accordance with the decision made in operation (d).

This configuration of the apparatus may allow monitoring and adjusting the current consumed by the EV from a different geographical location (even a different country) than that where the at least one EV charging station is deployed. Moreover, the apparatus thus configured may significantly decrease the risk of overloading an electrical grid and, consequently, fuse blowing because current adjustments are not made in real time.

In one implementation form of the second aspect, the at least one processor is configured to perform operation (b) by receiving actual-current measurements sent by the at least one EV charging station at regular intervals during the charging session. This may allow significantly reducing the requirements for the speed and intensity of data communication between the at least one EV charging station and a remote monitoring center.

In another implementation form of the second aspect, the at least one processor is configured to perform operation (b) by receiving the actual-current measurements sent by the at least one EV charging station at regular intervals and each time when the actual current changes during the charging session. This may provide more efficient non-real-time remote monitoring of the actual current.

In one implementation form of the second aspect, the at least one processor is configured to perform operations (a), (b) and (e) by using Open Charge Point Protocol (OCPP) messages. This may provide more efficient data communication between the at least one EV charging station and the remote monitoring center.

In one implementation form of the second aspect, the at least one processor is configured, in operation (d), to decide to: decrease the station current if the ratio is less than 0.80, or maintain the station current if the ratio is within the range of 0.80 to 0.90, or increase the station current if the ratio is more than 0.90. By so doing, the current adjustments may be made more efficiently.

In one implementation form of the second aspect, when there are two or more EV charging stations at which charging sessions are initiated for EVs, and each EV charging station is characterized by the same maximum allowable current, the at least one processor is configured to perform operations (a)-(e) to control the EV charging at each of the two or more EV charging stations. This may make the apparatus more flexible in use.

In one implementation form of the second aspect, the two or more EV charging stations are combined in a group of EV charging stations. The group of EV charging stations is characterized by a total current, and the maximum allowable current is less than the total current. In this case, the at least one processor is configured to calculate the station current as min(I₁, I₂), where min( ) is the function that returns the smallest value from the numbers provided, I₁ is the maximum allowable current of the EV charging stations, and I₂=Iₜₒₜₐₗ/N is the current obtained by evenly distributing the total current Iₜₒₜₐₗ of the group of EV charging stations among all N EVs that have initiated the charging sessions at the current time. By using the station current thus calculated, one may provide load balancing in the whole electrical grid.

According to a third aspect, a computer program product comprising a computer-readable storage medium storing a computer program is provided. Being executed by at least one processor, the computer program causes the at least one processor to perform the method according to the first aspect. Thus, the method according to the first aspect can be embodied in the form of the computer program, thereby providing flexibility in use thereof.

Other features and advantages of the present disclosure will be apparent upon reading the following detailed description and reviewing the accompanying drawings.

### BRIEF DESCRIPTION OF THE DRAWINGS

The essence of the present disclosure is explained below with reference to the accompanying drawings in which:

FIG. 1 shows a simplified diagram of an EV charging network typically deployed in a geographical region of interest;

FIG. 2 shows a block-scheme of an apparatus for the control of EV charging in accordance with one aspect of the present disclosure;

FIG. 3 shows a flowchart of a method for the control of EV charging in accordance with another aspect of the present disclosure.

### DETAILED DESCRIPTION

Various embodiments of the present disclosure are further described in more detail with reference to the accompanying drawings. However, the present disclosure can be embodied in many other forms and should not be construed as limited to any certain structure or function disclosed in the following description. In contrast, these embodiments are provided to make the description of the present disclosure detailed and complete.

According to the present disclosure, it will be apparent to those skilled in the art that the scope of the present disclosure covers any embodiment, which is disclosed herein, irrespective of whether this embodiment is implemented independently or in concert with any other embodiment of the present disclosure. For example, the apparatus and method disclosed herein can be implemented by using any numbers of the embodiments provided herein. Furthermore, it should be understood that any embodiment of the present disclosure can be implemented using one or more of the elements or operations presented in the appended claims.

As used herein, an electric vehicle or EV may refer to different kinds of electricity-driven vehicles, such as electric cars, aircrafts and vessels. With that said, an EV charging station may refer to a station properly deployed to charge corresponding one of these kinds of EVs. For example, the EV charging station may be arranged along roads to charge the electric cars. In case of the electric aircrafts, the EV charging station may be located at an airport. Being used for the electric vessels, the EV charging station may be located at a seaport.

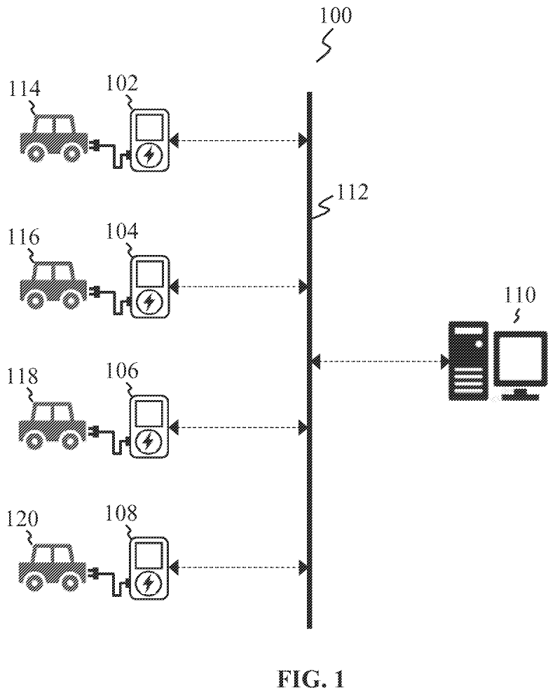

FIG. 1 shows a simplified diagram of an EV charging network 100 typically deployed in a geographical region of interest, such, for example, as a certain county, country or continent. As shown in FIG. 1, the EV charging network 100 comprises four EV charging stations 102, 104, 106, and 108, and a remote monitoring center 110 that may be arranged in a different geographical region (for example, a different county within the same country, or even a different country or continent) than the EV charging stations 102, 104, 106, and 108. The EV charging stations 102, 104, 106, and 108 are configured to communicate with the monitoring center 110 via a wire or wireless communication channel 112. Such communication may be two-directional, as schematically shown by double-headed dashed arrows in FIG. 1, and is used to provide energy measurements from the EV charging stations 102, 104, 106, and 108 to the monitoring center 110 and operation instructions in the opposite direction, i.e. from the monitoring center 110 to the EV charging stations 102, 104, 106, and 108. The energy measurements may be presented in different measurement units. As a rule, each EV charging station is provided with an energy meter configured to measure energy consumption in kilowatt-hours (kWh), which may then be converted to amperes (A) at the monitoring center 110 for further processing and making decisions on the station operation. In the EV charging network 100, the energy consumption is intended to be provided by an electric car 114 at the EV charging station 102, an electric car 116 at the EV charging station 104, an electric car 118 at the EV charging station 106, and an electric car 120 at the EV charging station 108. To make it possible for the monitoring center 110 to distinguish between the energy measurements of the EV charging stations 102, 104, 106, and 108, the energy measurements may be reported to the monitoring center 110 together with a timestamp, a station identifier (ID), and a charging session ID unique for each charging session.

There are different prior art solutions that may be used to control EV charging in the EV network 100. Some of them rely on real-time monitoring of electrical current that the electric cars 114, 116, 118, and 120 use for charging, with the real-time monitoring being performed locally, meaning that the monitoring center 110 is in the same geographical location as the EV charging stations 102, 104, 106, and 108. Others involve using real-time remote monitoring of the electrical current consumed by the electric cars 114, 116, 118, and 120, i.e. the monitoring center 110 may now be deployed in a different geographical location than the EV charging stations 102, 104, 106, and 108. Irrespective of the location of the monitoring center 110, these prior art solutions require current monitoring and adjustments to be made in real time: whenever a change in the electrical current takes place (for example, any of the electric cars 114, 116, 118, and 120 starts or stops charging, or changes its charging current), it is monitored immediately, and the current adjustments are performed immediately too. This is because, in the above-mentioned prior art solutions, each EV first starts charging by taking more (or excess) electrical current than it requires for its charging, whereafter the electrical current is reduced to a certain current value in real time depending on the actual EV needs. Therefore, in case of any delay in current adjustments, the whole electric grid may be overloaded, which in turn leads to fuse blowing at the EV charging stations 102, 104, 106, and 108. Furthermore, said real-time monitoring, either local or remote, requires huge and intensive data communication between the EV charging stations 102, 104, 106, and 108 and the monitoring center 110, and installations of special equipment at the EV charging stations 102, 104, 106, and 108 which support the huge and intensive data communication in real time.

The present disclosure provides a technical solution for the control of EV charging in an EV charging network like the network 100, with the technical solution being capable of mitigating or even eliminating the deficiencies indicated above. In particular, the technical solution described herein involves: initially providing each EV with a limited amount of station current, which may be even less than the EV really needs for its charging; determining whether the initial station current should be increased, decreased or maintained unchanged; and adjusting the station current based on the determination results. The station current may refer to an electrical current that an EV charging station initially provides to the EV after its charging session is initiated. As for said determining, it involves non-real-time monitoring of an actual current consumed by the EV during the charging session. In other words, the actual current may refer to that fraction of the station current which the EV is currently using for its charging. With that said, the actual current may be less than or roughly equal to the initial station current. The non-real-time monitoring of the actual current may be considered as a process of sending, from the EV charging station to a remote monitoring center, actual-current measurements with delay and periodically or aperiodically (i.e. when a change in the actual current takes place) during the charging session. By analyzing the actual current and the station current, the remote monitoring center may issue, on a non-real-time basis, a proper operation instruction to the EV charging station, i.e. whether to decrease, maintain or increase the station current. Unlike the prior art solutions, such delayed current adjustments will not cause the whole electric grid to be overloaded and fuses to blow because the station current initially provided to each EV is not excess but limited to a certain top level, as will be explained further in more detail.

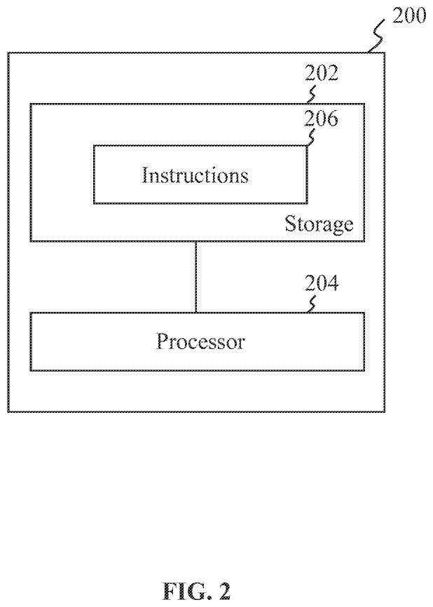

FIG. 2 shows a block-scheme of an apparatus 200 for the control of EV charging in accordance with one embodiment. The apparatus 200 is intended to be integrated into a remote monitoring center serving at least one EV charging station, like the monitoring center 110 serving the EV charging stations 102, 104, 106, and 108 in the EV charging network 100. As shown in FIG. 2, the apparatus 200 comprises a storage 202 and a processor 204 coupled to the storage 202. The storage 202 stores processor executable instructions 206 to be executed by the processor 204 to provide the control of EV charging. The apparatus 200 is configured to perform the operations described in the embodiments.

The storage 202 may be implemented as a nonvolatile or volatile memory used in modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor 204 may be implemented as a central processing unit (CPU), general-purpose processor, single-purpose processor, microcontroller, microprocessor, application specific integrated circuit (ASIC), field programmable gate array (FPGA), digital signal processor (DSP), complex programmable logic device, or the like. It is worth noting that the processor 204 may be implemented as any combination of the aforesaid. As an example, the processor 204 may be a combination of two or more CPUs, general-purpose processors, etc.

The processor executable instructions 206 stored in the storage 202 may be configured as a computer executable code causing the processor 204 to perform the embodiments. The computer executable code for carrying out operations or operations for the embodiments may be written in any combination of one or more programming languages, such as Java, C, C++, Python, or the like. In some examples, the computer executable code may be in the form of a high-level language or in a pre-compiled form, and be generated by an interpreter (also pre-stored in the storage 202) on the fly.

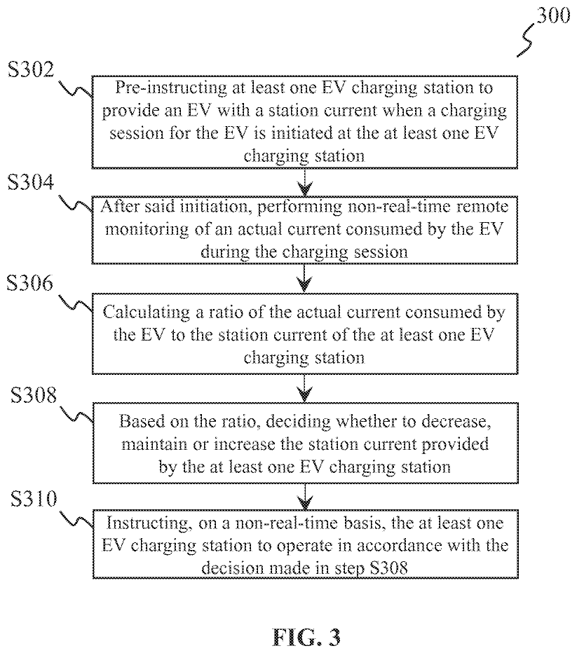

FIG. 3 shows a flowchart for a method 300 for the control of EV charging in accordance with another embodiment. The method 300 is intended to be performed by the processor 204 of the apparatus 200 when the processor 204 is caused to execute the processor executable instructions 206.

More specifically, the method 300 starts with the operation S302, in which the processor 204 pre-instructs at least one EV charging station (for example, at least one of the EV charging stations 102, 104, 106, and 108) to provide an EV (for example, corresponding one of the electric cars 114, 116, 118, and 120) with a station current when a charging session for the EV is initiated at the at least one EV charging station. The station current is set to be less than or equal to a maximum allowable current of the at least one EV charging station. In general, the station current and the maximum allowable current may depend on station equipment and/or current restrictions applied by a charging service provider to the at least one EV charging station. The charging session initiated for the EV may be reported to the processor 204 of the apparatus 200 by using special messages sent from the at least one EV charging station. In one embodiment, such messages may be configured as Open Charge Point Protocol (OCPP) messages.

Once the EV starts charging with the station current, the method 300 proceeds to operation S304, in which the processor 204 performs non-real-time remote monitoring of an actual current consumed by the EV during the charging session. The reason why it is necessary to monitor the actual current is that current consumption of the EV depends on its model and manufacturer. Thus, even if the at least one EV charging station initially provides the EV with the station current, the EV may indeed require current more or less than this initial station current. The non-real-time remote monitoring is performed by sending messages, for example, configured as the OCPP messages, about the actual current consumed by the EV from the at least one EV charging station to the processor 204 during the charging session. Whenever the processor 204 receives such a message, next operation S306 of the method 300 is executed, in which the processor 204 calculates a ratio of the actual current consumed by the EV to the station current of the at least one EV charging station.

Further, in operation S308, the processor 204 uses the ratio calculated in the operation S306 to decide how to adjust the station current provided by the at least one EV charging station. In particular, depending on which fraction of the station current the actual current is, the processor 204 may decide whether to decrease, maintain or increase the station current. For example, if the actual current is significantly less than the station current, for example, equal to half of the station current, the processor 204 may make a decision on decreasing the station current. If the actual current is roughly equal to the station current, the processor 204 may make a decision on increasing the station current. In the rest cases, the processor 204 may make a decision on maintaining the station current. Once such a decision is made in the operation S308, the method 300 proceeds to operation S310, in which the processor 204 instructs, for example via the OCPP messages, the at least one EV charging station to operate in accordance with the decision made. It should be noted that the at least one EV charging station is instructed in the operation S310 with delay, for which reason adjustments to the station current are made in non-real time. In the prior art solutions, these delayed adjustments would lead to overloading the electric grid and fuse blowing, as discussed above.

Thus, the apparatus 200 and the method 300 allow monitoring and adjusting the current consumed by the EV from a different geographical location (even a different country) than that where the at least one EV charging station is deployed. Moreover, the apparatus 200 and the method 300 allow reducing the risk of overloading the electrical grid and, consequently, fuse blowing because current adjustments are not made in real time. On top of that, the non-real-time remote monitoring used in the apparatus 200 and the method 300 does not require huge data communication between the EV charging stations and the remote monitoring center, thereby also avoiding costs for the local installations of special high-speed communication equipment at the EV charging stations.

In one embodiment, the operation S304 of the method 300 may be performed by sending the messages about the actual current consumed by the EV from the at least one EV charging station to the processor 204 of the apparatus 200 at regular intervals during the charging session. For example, the processor 204 may receive such information every 1-10 minutes. In another embodiment, the at least one EV charging station may send such messages with actual-current measurements at regular intervals and after each change in the actual current (caused by the EV itself for any reason) during the charging session This may allow significantly reducing the data communication between the at least one EV charging station and the processor 204.

In one embodiment, the operation S308 of the method 300 may be executed as follows:
(i) If the ratio of the actual current consumed by the EV to the station current of the at least one EV charging station is less than 0.80, this means that the EV needs less current for charging, and the processor 204 decides on decreasing the station current.
(ii) If the ratio is within the range of 0.80 to 0.90, this means that the station current is sufficient for charging the EV, and the processor 204 decides on maintaining the station current.
(iii) If the ratio is more than 0.90, this means that the EV requires more current for charging, and the processor 204 decides to increase the station current (of course, this increase should be limited to the maximum allowable current of the at least one EV charging station of interest).

By so doing, the EV may be charged more efficiently. However, it should be apparent that the ratio limits given above are not limitations of the present disclosure and may be replaced with any others depending on particular application.

In one embodiment, the station current provided by the at least one EV charging station in the operation S302 may be calculated as follows:

station current=min(I₁,I₂), (1)

where min( ) is the function that returns the smallest value from the numbers provided, I₁ is the maximum allowable current of the EV charging stations, and I₂=Iₜₒₜₐₗ/N is the current obtained by evenly dividing the total current Iₜₒₜₐₗ of a group consisting of the at least one EV charging station among all N EVs that have initiated the charging sessions at the current time.

Let us now consider one example in which the apparatus 200 and the method 300 are applied to the EV charging network 100 shown in FIG. 1. Assuming that the maximum allowable current of each of the EV charging stations 102, 104, 106, and 108 is 32 A, while a total current of the group of the EV charging stations 102, 104, 106, and 108 cannot exceed 80 A. Again, the maximum allowable current and the total current are defined based on station equipment and restrictions/requirements imposed by a charging service provider on the electrical grid as a whole. It is also assumed that all the electric cars 114, 116, 118, and 120 start charging at the same moment. According to equation (1), the station current which the EV charging stations 102, 104, 106, and 108 are pre-instructed, in the operation S302, to provide to the electric cars 114, 116, 118, and 120 is defined as follows:

$$station current = min ( 32 A , {I}_{2} = \frac{80 A}{4} = 20 A ) .$$

Thus, the EV charging stations 102, 104, 106, and 108 provides the electric cars 114, 116, 118, and 120, respectively, with the same station current 20 A.

Further, in the operation S304, the processor 204 performs the non-real-time remote monitoring of the actual current consumed by each of the electric cars 114, 116, 118, and 120. Let us again make the following assumptions: the electric car 114 uses 10 A, the electric car 116 uses 17.8 A, the electric car 118 uses 19.2 A, and the electric car 120 uses 19.4 A. As discussed above, these actual current values may be sent to the processor 204 by using the OCPP messages. Once the processor 204 receives this information, it proceeds to the operation S306, i.e. calculates the ratio of the actual current consumed by each of the electric cars 114, 116, 118, and 120 to the station current of the EV charging stations 102, 104, 106, and 108, respectively. Outcomes of the operation S306 are as follows:

$$\frac{10 A}{20 A} = 0.5 for the electric car 114 ,$$

$$\frac{17.8 A}{20 A} = 0.89 for the electric car 116 ,$$

$$\frac{19.2 A}{20 A} = 0.96 for the electric car 118 ,$$

$$\frac{19.4 A}{20 A} = 0.97 for the electric car 120.$$

Given these ratios and applying the same conditions (i)-(iii), the processor 204 decides, in the operation S308, that the station current should be decreased for the electric car 114, maintained for the electric car 116, and increased for both the electric cars 118 and 120. For example, the station current may be decreased to 10 A for the electric car 114 (i.e. to the value which the electric car 114 virtually needs), and “released” other 10 A (i.e. 20 A-10 A=10 A) may be distributed evenly between the electric cars 118 and 120. In other words, each of the electric cars 118 and 120 additionally obtains 5 A, whereupon their station current should be increased to 25 A. Here it should again be noted that the increase of the station current is limited to the maximum allowable current of the EV charging stations 102, 104, 106, and 108. The processor 204 sends corresponding operation instructions to the EV charging stations 102, 104, 106, and 108 in the last operation S310 of the method 300.

Another example will now be considered, in which only one of the electric cars 114, 116, 118, and 120 starts charging, while the rest three stops charging. For simplicity, the same values of the maximum allowable current (32 A) and the total current (80 A) are used in this example. If the charging session is initiated only for the electric car 114, the processor 204 will instruct, in the operation S302, the EV charging station 102 to provide the electric car 114 with the station current calculated as follows (given that the number of electric cars that have initiated the charging sessions is equal to 1):

station current=min(32 A,80 A).

Since the station current cannot exceed the maximum allowable current of the EV charging station 102, it should be set to 32 A. Thus, the electric car 114 will be provided with 32 A in the operation S302. The rest operations S304-S310 will be performed by the processor 204 depending on how much the actual current consumed by the electric car 114 differs from the station current 32 A. If the electric car 114 needs 10 A for its charging, then the station current may be decreased from 32 A to 10 A.

Those skilled in the art should understand that each block or operation of the method 300, or any combinations of the blocks or operations, can be implemented by various means, such as hardware, firmware, and/or software. As an example, one or more of the blocks or operations described above can be embodied by computer executable instructions, data structures, program modules, and other suitable data representations. Furthermore, the computer executable instructions which embody the blocks or operations described above can be stored on a corresponding data carrier and executed by at least one processor like the processor 204 of the apparatus 200. This data carrier can be implemented as any computer-readable storage medium configured to be readable by said at least one processor to execute the computer executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. An apparatus for the control of electric vehicle (EV) charging, comprising:
at least one processor; and
a memory coupled to the at least one processor and storing processor-executable instructions which, when executed by the at least one processor, cause the at least one processor to:
pre-instruct at least one EV charging station to provide an EV with a station current when a charging session for the EV is initiated at the at least one EV charging station;
after the initiation of the charging session, perform non-real-time remote monitoring of an actual current consumed by the EV during the charging session;
calculate a ratio of the actual current consumed by the EV to the station current of the at least one EV charging station;
based on the ratio, decide whether to decrease, remain or increase the station current provided by the at least one EV charging station; and
instruct, on a non-real-time basis, the at least one EV charging station to operate in accordance with the decision made in operation (d).

2. The apparatus of claim 1, wherein the at least one processor is configured to perform operation (b) by:
receiving actual-current measurements sent by the at least one EV charging station at regular intervals during the charging session.

3. The apparatus of claim 2, wherein the at least one processor is configured to perform operation (b) by:
receiving the actual-current measurements sent by the at least one EV charging station at regular intervals and after each change of the actual current during the charging session.

4. (canceled)

5. The apparatus of claim 1, wherein the at least one processor is configured, in operation (d), to decide to:
decrease the station current if the ratio is less than 0.80, or
maintain the station current if the ratio is within the range of 0.80 to 0.90, or
increase the station current if the ratio is more than 0.90.

6. The apparatus of claim 1, wherein when there are two or more EV charging stations at which charging sessions are initiated for EVs, and each EV charging station is characterized by an equal maximum allowable current, the at least one processor is configured to perform operations (a)-(e) to control the EV charging at each of the two or more EV charging stations.

7. The apparatus of claim 6, wherein the two or more EV charging stations are combined in a group of EV charging stations, the group of EV charging stations is characterized by a total current, and the maximum allowable current is less than the total current, and wherein the at least one processor is configured to calculate the station current as min(I₁, I₂), where min( ) is the function that returns the smallest value from the numbers provided, I₁ is the maximum allowable current of the EV charging stations, and I₂=Iₜₒₜₐₗ/N is the current obtained by evenly distributing the total current Iₜₒₜₐₗ of the group of EV charging stations among all N EVs that have initiated the charging sessions at the current time.

8. A method for the control of electric vehicle (EV) charging, comprising:
pre-instructing at least one EV charging station to provide an EV with a station current when a charging session for the EV is initiated at the at least one EV charging station;
after the initiation of the charging session, performing non-real-time remote monitoring of an actual current consumed by the EV during the charging session;
calculating a ratio of the actual current consumed by the EV to the station current of the at least one EV charging station;
based on the ratio, deciding whether to decrease, maintain or increase the station current provided by the at least one EV charging station; and
instructing, on a non-real-time basis, the at least one EV charging station to operate in accordance with the decision made in operation (d).

9. The method of claim 8, wherein operation (b) comprises:
receiving actual-current measurements sent by the at least one EV charging station at regular intervals during the charging session.

10. The method of claim 9, wherein operation (b) comprises:
receiving the actual-current measurements sent by the at least one EV charging station at regular intervals and after each change of the actual current during the charging session.

11. (canceled)

12. The method of claim 8, wherein operation (d) comprises:
deciding to decrease the station current if the ratio is less than 0.80, or
deciding to maintain the station current if the ratio is within the range of 0.80 to 0.90, or
deciding to increase the station current if the ratio is more than 0.90.

13. The method of claim 8, wherein there are two or more EV charging stations at which charging sessions are initiated for EVs, each EV charging station being characterized by an equal maximum allowable current, and wherein operations (a)-(e) are performed to control the EV charging at each of the two or more EV charging stations.

14. The method of claim 13, wherein the two or more EV charging stations are combined in a group of EV charging stations, the group of EV charging stations being characterized by a total current, and the maximum allowable current being less than the total current, and wherein the station current is calculated as min(I₁, I₂), where min( ) is the function that returns the smallest value from the numbers provided, I₁ is the maximum allowable current of the EV charging stations, and I₂=Iₜₒₜₐₗ/N is the current obtained by evenly distributing the total current Iₜₒₜₐₗ of the group of EV charging stations among all N EVs that have initiated the charging sessions at the current time.

15. A computer program product comprising a computer-readable medium that stores a computer program, wherein the computer program, when executed by at least one processor, causes the at least one processor to perform the method of claim 8.
